(19) United States
(12) Patent Application Publication
(10) Pub. No.: US 2010/0236188 A1
(43) Pub. Date: Sep. 23, 2010

(54) DOOR TRANSPORT AND INSTALLATION SYSTEM

(76) Inventor: Larry Charles Campbell, Merlose, WI (US)

Correspondence Address: Kenneth Bower, 314 Ironstone Lane, Elverson, PA, 19520, US

(21) Appl. No.: 12/409,383

(22) Filed: Mar. 23, 2009

(51) Int. Cl. E04G 21/14; E04G 21/00; B62B 1/26; B62B 1/00; B66F 3/35

(52) U.S. Cl. 52/745.15; 280/47.131; 414/10; 414/800; 92/92; 254/93 HP

(57) ABSTRACT

Disclosed is a transport and installation system that serves the purpose of convenient moving doors from the delivery to the place of installation, positioning doors for ease of hinge installation and providing for horizontal, straight vertical and angular position of the doors with the door jam for installation of the hinge mountings. The new and unique air actuator utilizes a base, stationery vertical guides and removable attachment to a hand cart to solve the problem of handling these heavy unwieldly objects.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention represents a significant step forward in the field of building construction and maintenance involving door installation and repair. Currently marketed hand cart and lifter apparatus sold for the purpose of door transport and installation do not address the problems of a door installer being able to transport wide doors or to lift the door straight up for convenient positioning of the door for hinge installation as well as the freedom to adjust the door position angularly for alignment with the door jam during installation. Recent declines in the price of residential and commercial buildings will increase the downward pressure on construction cost and schedules. This will naturally reduce the presence of an extra set of hands on the construction site when heavy materials have to be lugged into place. The instant invention is aimed at making it easier for a single worker to install a door quickly and with reduced chance of damage to the doors or the building.

2. Description of Related Art

The following is art representative of what is published in the field of work holders for doors. U.S. Pat. No. 6,513,418 to inventor Simmons et al. discloses a air actuator that has an air bladder, base and lift platform. However, the disclosure of inventor Simmons et al. lacks a solution to the problems of lateral stability of the object being lifted.

U.S. Pat. No. 4,492,369 to inventor Pohl discloses a Door Lifting and Centering Device For Hanging Heavy Doors that has a means of lifting a door in the center regardless of width and easy angular alignment of the door to the door jam during fastening of the hinges. However, the disclosure of inventor Pohl lacks a solution to the problems of transporting the door to the work sight, holding the door in position for installation of the hinges and requires separating the hinge into two pieces and tedious inserting the hinge pin to hang the door.

U.S. Pat. No. 4,978,132 to inventor Wilson et al. discloses a pivotal hand truck apparatus that has a three wheeled hand cart, with an door holding frame and lift platform. However, the disclosure of inventor Wilston et al. lacks a solution to the problems of transporting wide and narrow doors, lifting the door straight up for alignment of the door mountings and ease of angular movement of the door to adjust to door jam orientation. None of the above Patents or Published Patent Applications singly or in combination is seen to describe the present invention as claimed.

### BRIEF SUMMARY OF THE INVENTION

The present invention is a Door Transporting and Installation System for use in building construction and maintenance. Generally, the instant invention solves the problem of transporting and lifting wide and narrow doors by being removably attached to a hand cart, adjusting to the width of the door to reduce tipping of the door during installation and by lifting the door in a straight upward motion utilizing a pressurized air actuator. In addition to solving these problems added features that transport the door from the delivery to the work site going easily through door ways, placing the door in a position to facilitate attachment of hinges and easy angular alignment of the door to the door jam for fastening are also provided.

The preferred embodiment of the present invention provides additional unique features by having stationery guides keeping the door moving vertically during lifting and offering a simplified model for work where the doors are separately delivered to the work site. The primary objective of the present invention is to ease the difficult task of positioning a door that can weigh two hundred pounds into a position where screws line up and to reduce the fatigue of transporting these unwieldy objects.

A further objective of the present invention is to provide two transport devices in one by removing the door lift platform actuator and base from the lift cart when doors are not being transported.

A further objective of the present invention is to reduce manufacturing cost by utilizing a commercially available lift cart in the product.

A further objective of the present invention is to reduce handling of the door thereby reducing the opportunities to damage the door finishes.

### BRIEF DESCRIPTION OF THE SEVERAL VIEWS OF THE DRAWING(S)

FIG. 1: Is a perspective view of a first preferred embodiment of the present invention for use without a hand cart.

FIG. 2: Is a perspective view of a second preferred embodiment of the present invention for use with a hand cart.

FIG. 3: Is a perspective view of the first preferred embodiment of the present invention in the elevated position.

FIG. 4: Is a perspective view of a second preferred embodiment of the present invention installed on a hand cart.

FIG. 5a-5I: are diagrams of the method steps for using the hand cart attachable door transport and installation system.

### DETAILED DESCRIPTION OF THE INVENTION

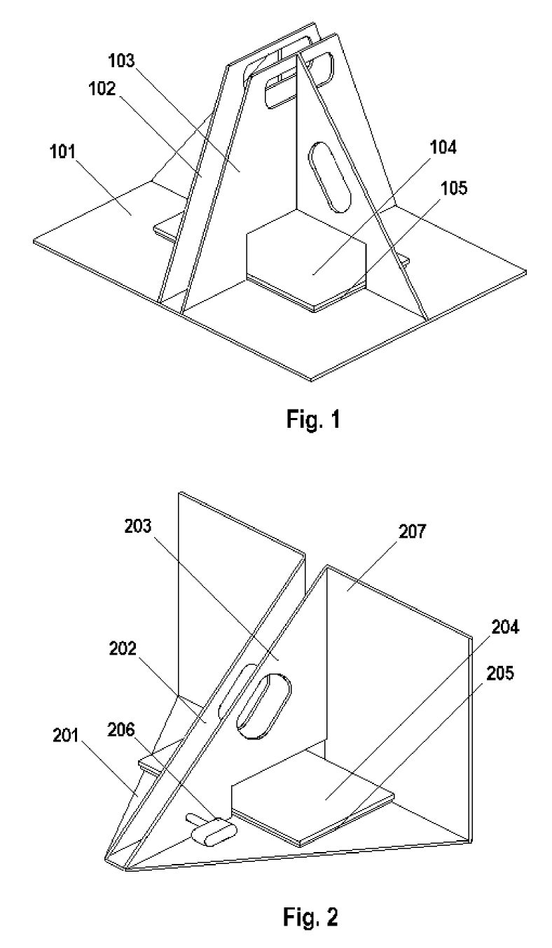

The first preferred embodiment of the present invention is shown in FIG. 1 with base 101 resting on the floor or other essentially horizontal surface. First vertical guide 102 and second vertical guide 103 extend in an essentially vertical direction from the base 101 forming a vertical space there between for guiding an object that is to be transported and lifted. The surfaces of the first vertical guide 102 and second vertical guide 103 may be lined with carpeting or other protective material to reduce the potential for damaging the doors during handling. The hose and pump for pressurizing the actuator and the valve for relieving the pressure on the actuator are (un-shown).

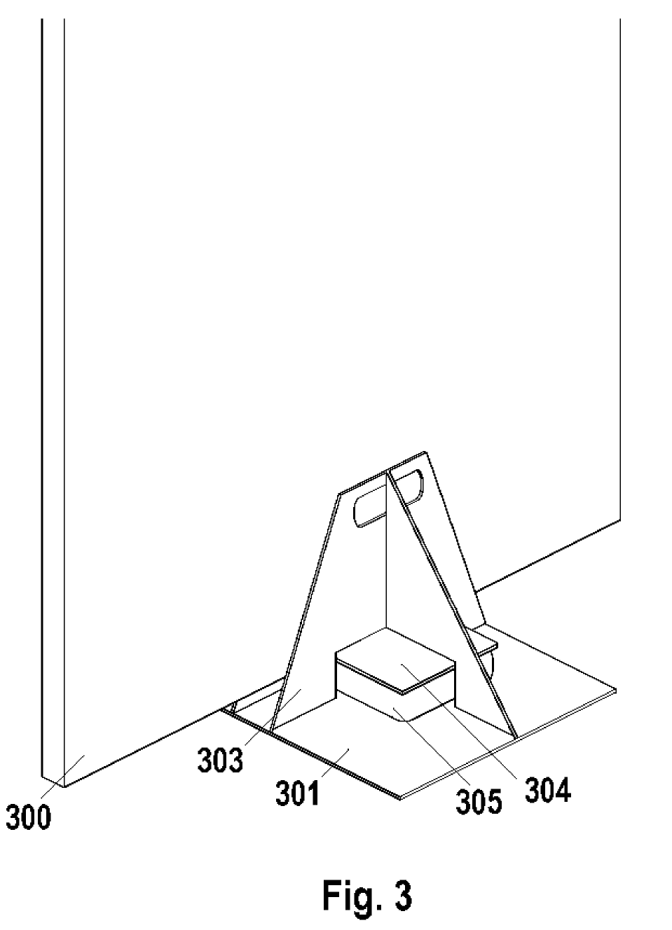

The second preferred embodiment of the present invention is shown in FIG. 2 with base 201 resting on the floor or other essentially horizontal surface. First vertical guide 202 and second vertical guide 203 extend in an essentially vertical direction from the base 201 forming a vertical space there between for guiding an object that is to be transported and lifted. A clamp actuator 206 applies a pressure on the object (un-shown) to hold the base 101 to the object (un-shown). The hose and pump for pressurizing the actuator and the valve for relieving the pressure on the actuator are (un-shown).

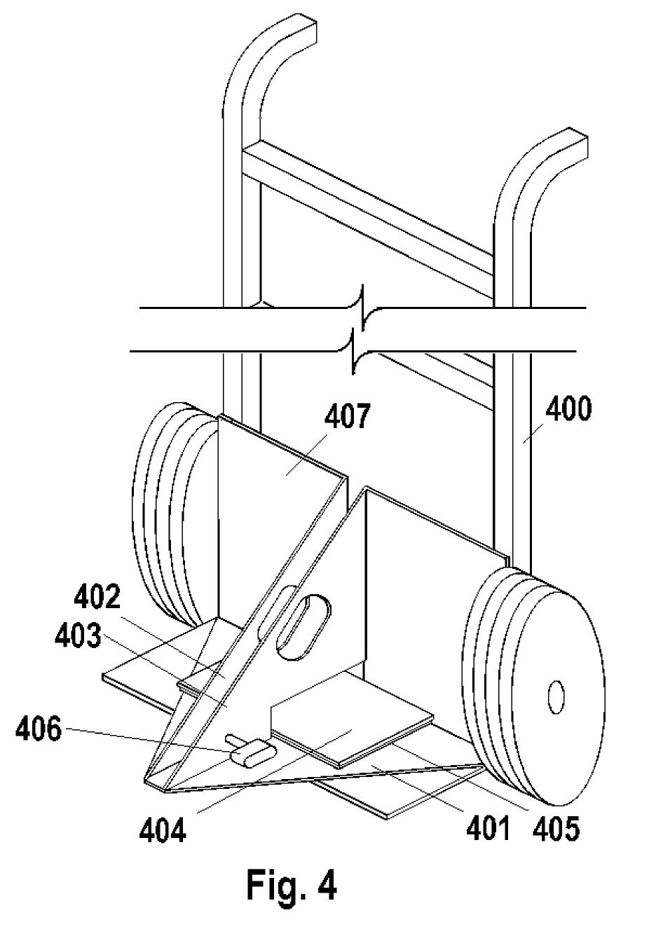

FIG. 3 shows the first preferred embodiment of the present invention with its base 301 resting on the floor with a door 300 guided in an upward position by vertical guides 302 and 303. Pressurized fluid actuator 305 is shown inflated raising lift platform 304 to an elevated position. The hose and pump for pressurizing the actuator and the valve for relieving the pressure on the actuator are (un-shown).

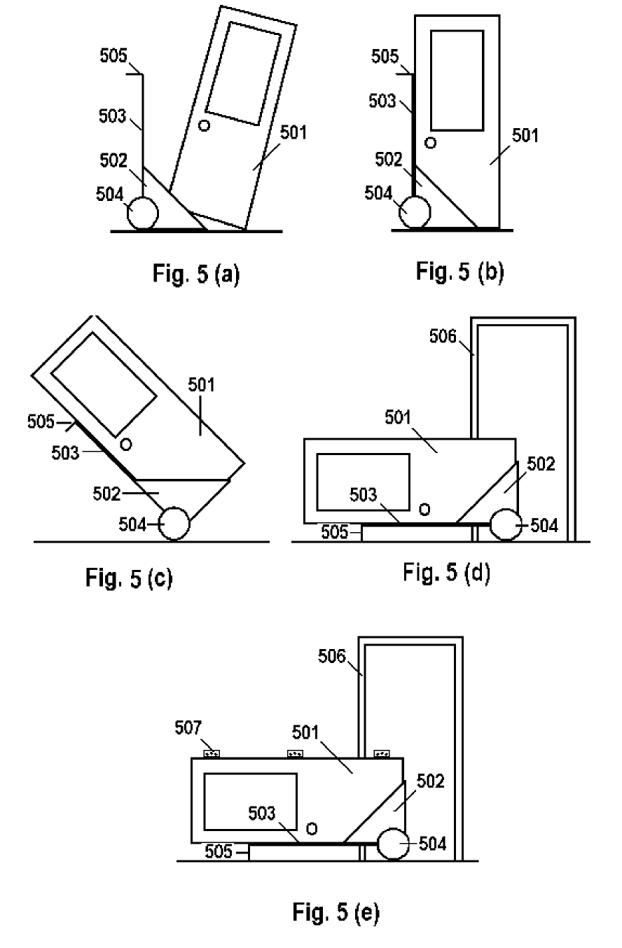

The second preferred embodiment of the present invention is shown in FIG. 4 with base 401 resting on the floor or other essentially horizontal surface. First vertical guide 402 and second vertical guide 403 extend in an essentially vertical direction from the base 401 forming a vertical space there between for guiding an object that is to be transported and lifted. A clamp actuator 406 applies a pressure on the object (un-shown) to hold the base 401 to the object (un-shown). The hose and pump for pressurizing the actuator and the valve for relieving the pressure on the actuator are (un-shown).

The advantages of using the door transport and installation system of the present invention is that a door installer (un-shown) can complete an installation without having the lift more than half the weight of the door. This is largely because half of the weight of the door is supported by a corner of the door being supported by the floor when ever the door installer (un-shown) tips the door into the next position. The only time that the entire door 501 is elevated the platform 404 is utilized and lifting is done under the mechanical advantage afforded by the pneumatic lift system.

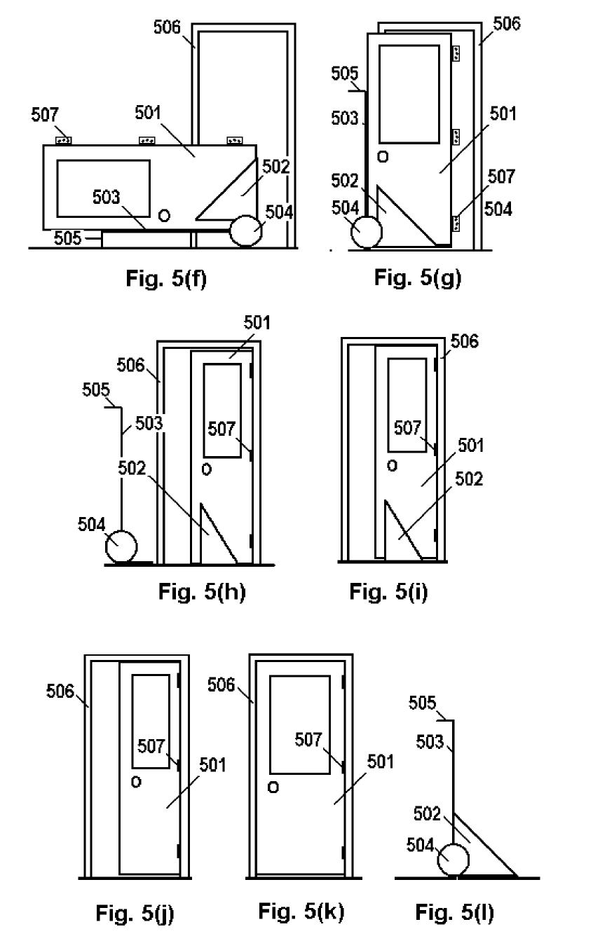

FIG. 5(a) is a diagram of the first step of using the hand cart attachable door transport system which involves tipping the door 501 onto the door support 502. FIG. (5) shows the door 501 being slid into position against the upright of the hand cart 503. In FIG. 5(c) the operator (un-shown) holding the handles 505 tips the hand cart 503 and the door 501 onto the wheels 504 and transports the door 501 in a position where unlike other hand cart door transporting systems the face of the door 501 is perpendicular to the wheel axles allowing easy egress through door ways that lead to the worksite represented by door jam 506 in FIG. 5(d). At this point the operator (un-shown) tips the hand cart 503 and door 501 so that the handles 505 rest on the floor. At this point the door 501 is supported by two handles 505 and two wheels 504. FIG. 5(e) illustrates the ease of installing the hinges 507 (typically 3 hinges) onto the door 501. This is another large improvement with the instant invention where the door installer (un-shown) here to fore has had to install the hinges onto a vertical edge of the door. An optional method at this point is to install half of one or more hinges 507 onto the door 501 and the other half of the one or more hinges 507 on the door jam 506 for re-attachment when the door 501 is lifted into place against the door jam 506. At FIG. 5(f) the door support 502 us loosened from the cart 503 and is positioned in the center of the bottom of the door 501 in preparation for the door installation. The door is tipped up by means of the handles 505 in FIG. 5(g). At FIG. 5(h) the door support 502 and door 501 are slid off of the hand cart and across the floor into a position where the hinges 507 line up horizontally with the mounting holes in the door jam 506 (note the gap between the top of the door 501 and the door jam 506). At FIG. 5(i) the platform in the door support 502 is raised until the mounting holes in the hinges 507 and the mounting holes in the door jam 506 line up vertically (note that the gap at the top of the door 501 has been reduced and a gap has appeared between the door 501 and the floor. At FIG. 5(j) the operator (un-shown has sold the door support 502 to the left and out from under door 501. The door 501 is fully installed and in a closed position in FIG. 5(k) and the door support 502 has been re-attached to the hand cart 503 in FIG. 5(l).

I claim:

1. An apparatus for lifting an object having a base and two essentially parallel sides, comprising:
a base for sitting on an essentially horizontal surface;
a lift platform that translates vertically at least partially within the space between the first and second vertical surfaces;
a fluid pressurized actuator located between the base and the lift platform;
wherein the actuator increases and decreases the distance between the base and the lifting platform thereby elevating the object.

2. The apparatus of claim 1, wherein:
the fluid pressurized actuator is an air bladder.

3. The apparatus of claim 2, further comprising:
a pump for pressurizing the air;
a valve for de-pressurizing the air.

4. The apparatus of claim 2, further comprising:
a foot pump for pressurizing the air;
a valve for de-pressurizing the air.

5. The apparatus of claim 1, wherein:
one or more of the base or lift platform have a plastic surface for protecting the pressurized fluid actuator.

6. The apparatus of claim 1, further comprising:
an first essentially vertical surface extending upward from the essentially horizontal surface;
a second essentially vertical surface extending upward from the essentially horizontal surface;
wherein the first and second vertical surfaces are spaced apart a distance to exceed the distance between the two essentially parallel surfaces of the object.

7. An apparatus for lifting an object having a base and two essentially parallel sides, comprising:
a base for sitting on an essentially horizontal surface;
a lift platform that translates vertically at least partially within the space between the first and second vertical surfaces;
a fluid pressurized actuator located between the base and the lift platform;
wherein the actuator increases and decreases the distance between the base and the lifting platform thereby elevating the object,
wherein the base is adapted for attachment to a wheeled vehicle.

8. The apparatus of claim 7, wherein:
the wheeled vehicle is a hand cart.

9. The apparatus of claim 7, wherein:
the fluid pressurized actuator is an air bladder.

10. The apparatus of claim 9, further comprising:
a foot pump for pressurizing the air;
a valve for de-pressurizing the air.

11. The apparatus of claim 10, wherein:
one or more of the base or lift platform have a plastic surface for protecting the pressurized fluid actuator.

12. The apparatus of claim 7, further comprising:
an first essentially vertical surface extending upward from the essentially horizontal surface;
a second essentially vertical surface extending upward from the essentially horizontal surface;
wherein the first and second vertical surfaces are spaced apart a distance to exceed the distance between the two essentially parallel surfaces of the object.

13. A method of transporting and installing a door, comprising the steps:
positioning a door in the upright position on the lift platform of a wheeled vehicle;
transporting the door to the site of installation with the door positioned perpendicular to the direction of travel;
re-positioning the door and the lift platform for installation of hinges;
re-positioning the door and lift platform to an upright position adjacent a door jam;
lifting the door and lift platform to line up the hinges with one or more mounting holes;
fastening the door to the door jam;
lowering the lift platform;
removing the lift platform from under the door.

14. The method of claim 13 further comprising the step:
inflating a pressurized fluid actuator for lifting the door and the lift platform.

15. The method of claim 14 further comprising the step:
separating the lift platform from the wheeled vehicle prior to lifting the door and lift platform.

16. The method of claim 13 further comprising the step:
re-positioning the door angularly to line up the hinges with one or more mounting holes.

17. A method of transporting and installing a door, comprising the steps:
positioning a door in the upright position on the lift platform of a wheeled vehicle;
transporting the door to the site of installation with the door positioned perpendicular to the direction of travel;
re-positioning the door and the lift platform for installation of one or more partial hinges;
installing one or more partial hinges on the door and the door jam;
installing full hinges in remaining hinge positions;
re-positioning the door and lift platform to an upright position adjacent a door jam;
lifting the door and lift platform to line up the hinges with one or more mounting holes;
fastening the door to the door jam;
lowering the lift platform;
removing the lift platform from under the door.

18. The method of claim 13 further comprising the step:
inflating a pressurized fluid actuator for lifting the door and the lift platform.

19. The method of claim 14 further comprising the step:
aligning the partial hinges on the door with the partial hinges on the door jam.

20. The method of claim 13 further comprising the step:
installing the partial hinge pins;
fastening the remaining hinges to the door jam.
